(19) United States
(12) Patent Application Publication
(10) Pub. No.: US 2019/0043431 A1
(43) Pub. Date: Feb. 7, 2019

(54) DISPLAY DEVICE, ELECTRONIC APPARATUS, AND METHOD OF DRIVING DISPLAY DEVICE

(71) Applicant: SEIKO EPSON CORPORATION, Tokyo (JP)

(72) Inventor: Osamu NAKAJIMA, Suwa-shi (JP)

(73) Assignee: SEIKO EPSON CORPORATION, Tokyo (JP)

(21) Appl. No.: 16/048,662

(22) Filed: Jul. 30, 2018

(30) Foreign Application Priority Data
Aug. 3, 2017 (JP) 2017-150474

(51) Int. Cl. G09G 3/34; G09G 3/00; G09G 3/36

(52) U.S. Cl. CPC G09G 3/3406; G09G 3/002; G09G 2320/0233; G09G 2320/064; G09G 2320/0646; G09G 3/3648

(57) ABSTRACT

In an electro-optical panel, a plurality of pixels are provided, each pixel corresponding to each of intersections between a plurality of scanning lines and a plurality of data lines, and each pixel includes a pixel circuit including a pixel transistor. In the electro-optical panel, a relationship

f_{pwm}≥f_{V}·Vₜₒₜₐₗ

is satisfied where a panel frequency fᵥ is an inverse number of one frame period t_{V}, Vₜₒₜₐₗ is a total number of the scanning lines per one frame of the electro-optical panel, and f_{pwm} is a PWM frequency of pulse width modulation of a laser light source (light emitting element).

The present application is based on and claims priority from JP Application Serial Number 2017-150474, filed Aug. 3, 2017, the disclosure of which is hereby incorporated by reference herein in its entirety.

### BACKGROUND

### 1. Technical Field

The disclosure relates to a display device that uses a pulse-width modulated light emitting element as a light source of an electro-optical panel, an electronic apparatus, and a driving method of the display device.

### 2. Related Art

An electro-optical panel used for a display device, such as a liquid crystal panel, includes a plurality of scanning lines extending along a first direction, a plurality of data lines extending along a second direction intersecting the first direction, and a plurality of pixels, each pixel being provided to correspond to each of intersections between the plurality of scanning lines and the plurality of data lines. Each pixel includes a pixel circuit electrically coupled to the data line and the scanning line. In such a display device, each of the scanning lines is sequentially driven for every horizontal scan period, and at the same time, an image signal is supplied to the pixel circuit of each pixel via the data lines, and thus, a light source light emitted from a light source is modulated. Meanwhile, it is conceivable that a display device uses, as the light source, a light emitting element such as a laser element and a light emitting diode, and in such a display device, a light source light that is pulse-width modulated is emitted from the light emitting element (see JP-A-2008-15296). In the display device described in JP-A-2008-15296, it is conceivable to optimize a relationship between a polarity reversal frequency in a liquid crystal panel, which is used as an electro-optical panel, and a PWM frequency of the pulse width modulation of the light emitting element.

In a case where an image is displayed while using a pulse width modulation system for driving the light emitting element, which is used as the light source, scroll noise, in which a gradation difference that extends in the horizontal direction is transferred to the vertical direction, may be generated. The technology described in JP-A-2008-15296 is considered to be incapable of resolving such an issue.

### SUMMARY

As a result of examining causes of scroll noise, the inventor has gained the following new knowledge. An optical leakage current is generated in a pixel transistor provided in each pixel, for example, during an illumination period of pulse width modulation on a light emitting element, thus a luminance of a pixel row for which an entire horizontal scan period is the illumination period is reduced compared to a luminance of other pixel rows, and this causes the scroll noise.

The disclosure provides a display device, an electronic apparatus, and a method of driving the display device, which are capable of suppressing generation of scroll noise, even in a case where a pulse width modulation method is used for driving a light emitting element used as a light source.

The display device according to the disclosure includes a light emitting element configured to emit a light source light that is pulse-width modulated, and an electro-optical panel configured to modulate the light source light. The electro-optical panel includes a plurality of scanning lines extending along a first direction, a plurality of data lines extending along a second direction intersecting the first direction, and a plurality of pixels, wherein each pixel includes a pixel circuit and is provided to correspond to each of intersections between the plurality of scanning lines and the plurality of data lines, and the pixel circuit includes a transistor. A panel frequency f_{V}, a total number of scanning lines Vₜₒₜₐₗ, and a PWM frequency f_{pwm} satisfy a following relationship,

f_{pwm}≥f_{V}·Vₜₒₜₐₗ,

where the panel frequency f_{V} is an inverse number of one frame period t_{V} of the electro-optical panel, Vₜₒₜₐₗ is a total number of scanning lines per one frame of the electro-optical panel, and f_{pwm} is a PWM frequency of pulse width modulation of the light emitting element.

The disclosure includes a light emitting element configured to emit a light source light that is pulse-width modulated, and an electro-optical panel configured to modulate the light source light. In a driving method of a display device, the display device includes the electro-optical panel including a plurality of scanning lines extending along a first direction, a plurality of data lines extending along a second direction intersecting the first direction, and a plurality of pixels, each pixel including a pixel circuit, the pixel circuit being provided to correspond to each of intersections between the plurality of scanning lines and the plurality of data lines, and the pixel circuit including a transistor. A panel frequency f_{V}, a total number of scanning lines Vₜₒₜₐₗ, and a PWM frequency f_{pwm} satisfy a relationship

f_{pwm}≥f_{V}·Vₜₒₜₐₗ

where the panel frequency f_{V} is an inverse number of one frame period t_{V} of the electro-optical panel, Vₜₒₜₐₗ is a total number of scanning lines per one frame of the electro-optical panel, and f_{pwm} is a PWM frequency of the pulse width modulation of the light emitting element.

In the disclosure, the panel frequency f_{V}, the total number of scanning lines Vₜₒₜₐₗ and the PWM frequency f_{pwm} satisfy the relationship

f_{pwm}≥f_{V}·Vₜₒₜₐₗ,

and thus a pulse width modulation cycle t_{pwm}, of the light emitting element, which is equal to 1/fpwm, is shorter than a cycle of one horizontal scan period t_{1H}. Thus, even in a case where an optical leakage current is generated in the transistor of the pixel circuit provided in each pixel during an illumination period of pulse width modulation on the light emitting element, causing a reduction in luminance of pixels, for example, such pixels only exist in a part of the pixel rows in the horizontal direction, and thus, a stripe-like gradation difference does not occur over the entire horizontal direction. Thus, even in a case where a pulse width modulation method is used for driving the light emitting element used as a light source, generation of scroll noise is suppressed.

In the disclosure, an aspect may be adopted in which the light emitting element is a laser element.

In the disclosure, an aspect may be adopted in which each pixel includes a liquid crystal element including a liquid crystal layer disposed between a pair of substrates.

In the disclosure, an aspect may be adopted in which each pixel includes a mirror configured to reflect the light source light, and an actuator configured to actuate the mirror. In this case, an aspect may be adopted in which, a relationship

f_{pwm}>fₘᵢᵣᵣₒᵣ

is satisfied, where fₘᵢᵣᵣₒᵣ is a drive frequency of the mirror by the actuator, f_{pwm} is the PWM frequency and fₘᵢᵣᵣₒᵣ is the drive frequency.

The display device according to the disclosure is used for various types of electronic apparatus. In a case where the electronic apparatus is a projection-type display device, the electronic apparatus includes a projection optical system configured to project a modulated light obtained by the electro-optical panel modulating the light source light. In such a projection-type display device, although a strong light is supplied to the electro-optical panel, the generation of the scroll noise is suppressed even in such a case, according to the disclosure.

### BRIEF DESCRIPTION OF THE DRAWINGS

Embodiments of the disclosure will be described with reference to the accompanying drawings, wherein like numbers reference like elements.

FIG. 1 is an explanatory diagram illustrating the configuration of a projection-type display device according to Exemplary Embodiment 1 of the disclosure.

FIG. 2 is a plan view of an electro-optical panel (a liquid crystal panel) used in a liquid crystal light valve illustrated in FIG. 1.

FIG. 3 is an explanatory diagram schematically illustrating the cross section of the electro-optical panel illustrated in FIG. 2.

FIG. 4 is a block diagram illustrating the electrical configuration of the electro-optical panel illustrated in FIG. 2.

FIG. 5 is a cross-sectional diagram schematically illustrating a configuration example of pixels of the electro-optical panel illustrated in FIG. 2.

FIG. 6 is an explanatory diagram of a scanning signal and the like supplied to scanning lines illustrated in FIG. 4.

FIG. 7 is an explanatory diagram illustrating a state in which scroll noise is suppressed in a case where the disclosure is applied.

FIGS. 8A and 8B are explanatory diagrams of an electro-optical panel using a digital mirror device, which is used instead of the liquid crystal valve, in the projection-type display device illustrated in FIG. 1.

FIG. 9 is an explanatory diagram illustrating a relationship between a PWM cycle and a drive cycle in Exemplary Embodiment 2 of the disclosure.

FIG. 10 is an explanatory diagram illustrating a relationship between the PWM cycle and the drive cycle in a reference example in relation to Exemplary Embodiment 2 of the disclosure.

### DESCRIPTION OF EXEMPLARY EMBODIMENTS

Exemplary Embodiments of the disclosure will be described below with reference to the accompanying drawings.

### Exemplary Embodiment 1

### Configuration of Projection-Type Display Device

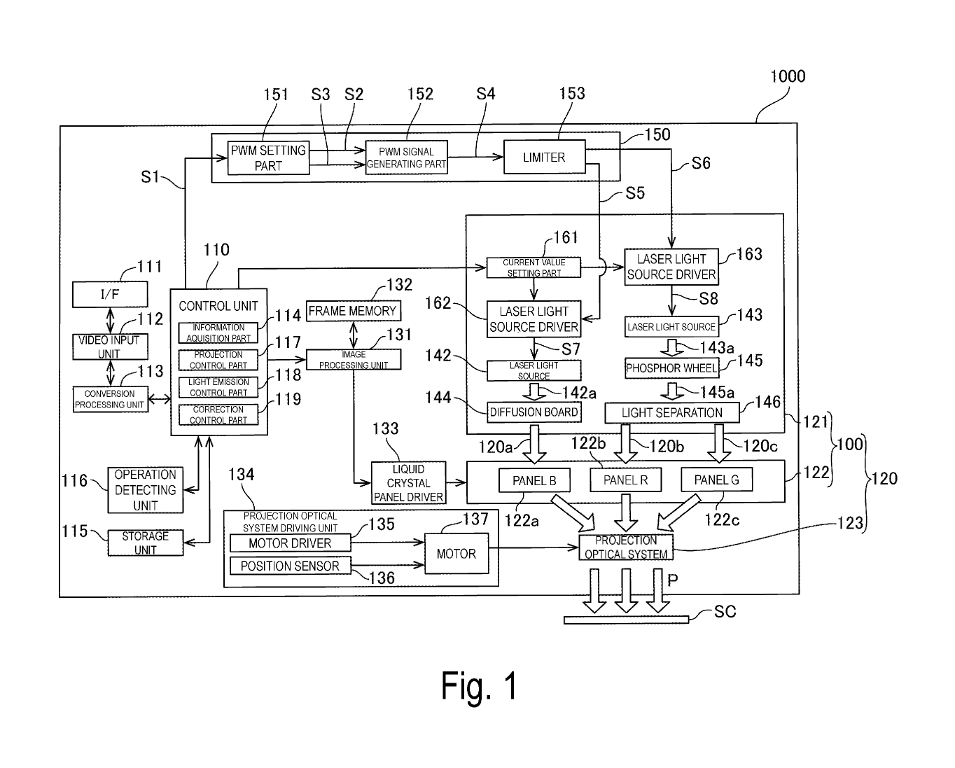

FIG. 1 is an explanatory diagram illustrating the configuration of a projection-type display device 1000 according to Exemplary Embodiment 1 of the disclosure. The projection-type display device 1000 illustrated in FIG. 1 includes an I/F (interface) 111 coupled to an image supply device, such as a computer including a portable terminal, a PC and the like. The projection-type display device 1000 is configured to project a projection image P, which is based on a digital image data input from the above-described image supply device via the interface 111, onto a projection target member, such as a screen SC. The projection-type display device 1000 includes a projection device 120 that is configured to optically form an image, and an image processing system that is configured to electrically process an image signal input into the projection device 120, each of which is configured to operate in accordance with control by a control unit 110.

The projection device 120 includes a display device 100 that includes a light source unit 121 and a light modulation device 122, and a projection optical system 123. The light source unit 121 includes a light emitting element, such as a laser element and a light emitting diode. In Exemplary Embodiment 1, the light source unit 121 includes laser light sources 142 and 143 that are configured to use two blue semiconductor laser elements (light emitting elements), each of which is configured to emit a blue laser light.

The light modulation device 122 is configured to receive a signal from the image processing system, which will be described later, modulate the light emitted from the light source unit 121, generate an image light and output the image light. The light modulation device 122 includes a liquid crystal light valve 122a that is configured to modulate blue light (B), a liquid crystal light valve 122b that is configured to modulate red light (R), and a liquid crystal light valve 122c that is configured to modulate green light (G). The liquid crystal light valves 122a. 122b, and 122c are configured to be driven by a liquid crystal panel driver 133, and change transmittance of the light in each pixel arranged in a matrix pattern to form an image. Each of the RGB colored lights modulated by the light modulation device 122 is combined using a cross dichroic prism (not illustrated), and guided to the projection optical system 123. The projection optical system 123 includes a lens group and the like that are configured to project the light modulated by the light modulation device 122 onto the screen SC. Further, the projection optical system 123 is configured to be driven by a motor 137 provided in a projection optical system driving unit 134, and cause a zoom adjustment, a focus adjustment, a diaphragm adjustment, and the like to be performed. The projection optical system driving unit 134 includes a motor driver 135 and a position sensor 136. The projection optical system 123 may be configured such that the zoom adjustment, the focus adjustment, the diaphragm adjustment, and the like are performed by the lens group being manually operated.

The light source unit 121 includes laser light source drivers 162 and 163 that are configured to respectively control the laser light sources 142 and 143 in accordance with the control unit 110. The light source unit 121 further includes a current value setting part 161 that is configured to set a current value for the laser light source drivers 162 and 163 in accordance with the control of the control unit 110. The light source unit 121 includes a diffusion board 144 that is configured to diffuse colored light, a phosphor wheel 145 that is configured to convert incident colored light into colored light of predetermined color, and a light separation part 146 that is configured to separate the incident colored light into colored lights of predetermined colors. The light source unit 121 is coupled to a light source driving unit 150 that is configured to output pulse signals S5 and S6, which control light emission of the laser light sources 142 and 143. Based on a power source supplied from a power supply circuit (not illustrated) of the projection-type display device 1000, the laser light source driver 162 is configured to be synchronized with the pulse signal S5 input from the light source driving unit 150, and generate a pulse current S7 having a current value set by the current value setting part 161. The laser light source driver 162 is configured to supply the generated pulse current S7 to the laser light source 142. Based on the power source supplied from the power supply circuit of the projection-type display device 1000, the laser light source driver 163 is configured to be synchronized with the pulse signal S6 input from the light source driving unit 150, and generate a pulse current S8 having a current value set by the current value setting part 161. The laser light source driver 163 is configured to supply the generated pulse current S8 to the laser light source 143.

Thus, a duration (pulse width) of an ON period, a duration of an OFF period, and a pulse cycle of pulses of the pulse currents S7 and S8 are determined by the pulse signals S5 and S6 input from the light source driving unit 150. The current values of the pulse currents S7 and S8 are determined by the control unit 110, and the determined current values are set by the current value setting part 161.

The pulse currents S7 and S8 are the currents that turn on and off the laser light sources 142 and 143 with a pulse width modulation (PWM) control. The laser light sources 142 and 143 are turned on during the ON period of the pulses of the pulse currents S7 and S8, and turned off during the OFF period of the pulses of the pulse currents S7 and S8. The pulse currents S7 and S8 are signals that are switched on and off at a high speed, the laser light sources 142 and 143 are repeatedly turned on and off at a high speed, and the luminance of the laser light sources 142 and 143 is determined by a ratio between a time period that the laser light sources 142 and 143 are turned on and a time period that the laser light sources 142 and 143 are turned off. Thus, the current value setting part 161 is capable of adjusting the luminance of the laser light sources 142 and 143 in accordance with the ratio between the ON period and the OFF period of the pulses of the pulse currents S7 and S8.

The laser light source 142 is configured to emit a blue laser light 142a, and this blue laser light 142a is made incident to the diffusion board 144 and diffused. The laser light diffused by the diffusion board 144 is made incident to the liquid crystal light valve 122a as a blue light 120a and is modulated. Meanwhile, the laser light source 143 is configured to emit a blue laser light 143a. The blue laser light 143a is made incident to a phosphor of the phosphor wheel 145 and converted into a yellow light 145a, and the converted yellow light 145a is made incident to the light separation part 146. The light separation part 146 is configured to separate the incident yellow light 145a into a red light 120b and a green light 120c based on wavelength components, and the separated red light 120b and green light 120c are made incident to the liquid crystal light valve 122b and the liquid crystal light valve 122c, respectively.

The light source driving unit 150 includes a PWM setting part 151, a PWM signal generating part 152, and a limiter 153. The light source driving unit 150 is configured to control the laser light source drivers 162 and 163 in accordance with a control signal S1 input from the control unit 110, turn on and off the laser light sources 142 and 143 and adjust the luminance of the laser light sources 142 and 143 with the PWM control of the laser light sources 142 and 143. The PWM setting part 151 is configured to generate and output, in accordance with the control signal S1 input from the control unit 110, a PWM frequency signal S2 that specifies a pulse frequency, and an ON period specification signal S3 that specifies a pulse width. In accordance with the PWM frequency signal S2 and the ON period specification signal S3 that are input from the PWM setting part 151, the PWM signal generating part 152 is configured to generate and output a PWM signal S4 that includes pulses that cause the laser light sources 142 and 143 to be turned on. The PWM signal S4 output by the PWM signal generating part 152 is input into the limiter 153. The limiter 153 is a filter that is configured to filter out a pulse whose pulse width is smaller than a preset value among the pulses included in the PWM signal S4. The limiter 153 is configured to output the pulse signals S5 and S6 to the laser light source drivers 162 and 163 of the light source unit 121.

The projection-type display device 1000 includes a video input unit 112 and a conversion processing unit 113. The conversion processing unit 113 is configured to perform scaling processing, such as resolution conversion, on an image data input into the video input unit 112 via the interface 111. The image data is then output to the control unit 110.

The projection-type display device 1000 includes the control unit 110 that is configured to control the projection-type display device 1000 as a whole. Further, the projection-type display device 1000 includes a storage unit 115 that is configured to store data to be processed by the control unit 110 and a control program to be executed by the control unit 110. Further, the projection-type display device 1000 includes an operation detecting unit 116 that is configured to detect an operation performed by a remote controller, an operation panel and the like. Further, the projection-type display device 1000 includes an image processing unit 131 that is configured to process image data, and a liquid crystal panel driver 133 that is configured to perform rendering by causing the liquid crystal light valves 122a, 122b, and 122c of the light modulation device 122 to be driven based on image signals that are output from the image processing unit 131.

The image processing unit 131 is configured to receive the image data output from the conversion processing unit 113 in accordance with the control of the control unit 110, and determine, attributes of the image data such as an image size, resolution, whether the image is a still image or a moving image, and a frame rate in a case where the image is the moving image. Then, the image processing unit 131 is configured to develop an image for each frame in a frame memory 132. Further, in a case where a resolution of the obtained image data is different from a display resolution of the liquid crystal light valves 122a, 122b, and 122c of the light modulation device 122, the image processing unit 131 is configured to perform resolution conversion processing on the obtained image data.

The control unit 110 is configured to function as a projection control part 117, a light emission control part 118, an information acquisition part 114, and a correction control part 119 by executing the control programs stored in the storage unit 115. The projection control part 117 is configured to initialize each component of the projection-type display device 1000 in accordance with the operation detected by the operation detecting unit 116. The projection control part 117 is configured to control the light source driving unit 150 to turn on the laser light sources 142 and 143, control the image processing unit 131 and the liquid crystal panel driver 133 to cause the liquid crystal light valves 122a, 122b, and 122c to render an image, and cause an image light to be projected on the screen SC.

Configuration of Electro-Optical Panel 100p

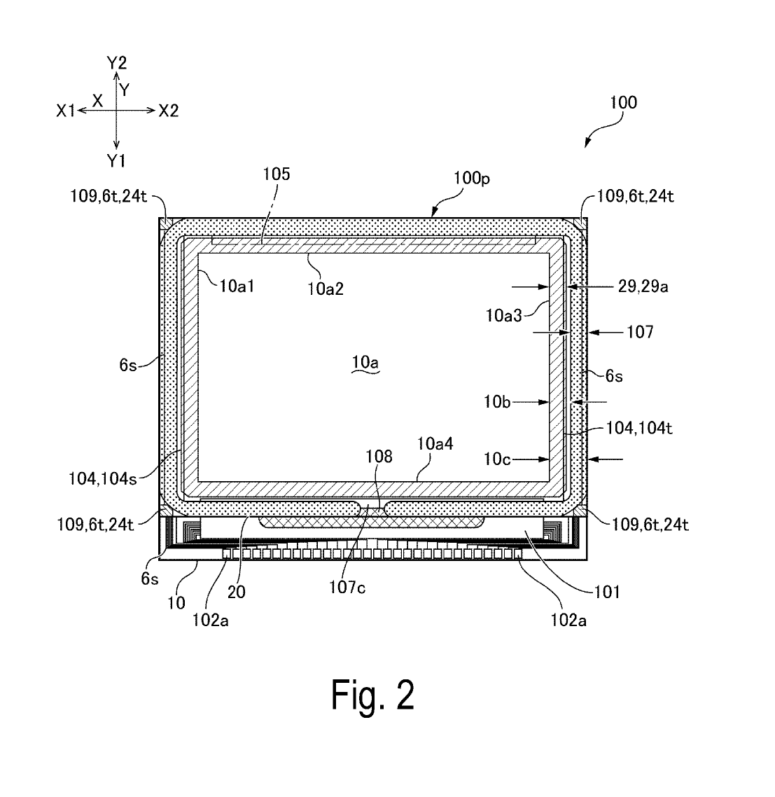

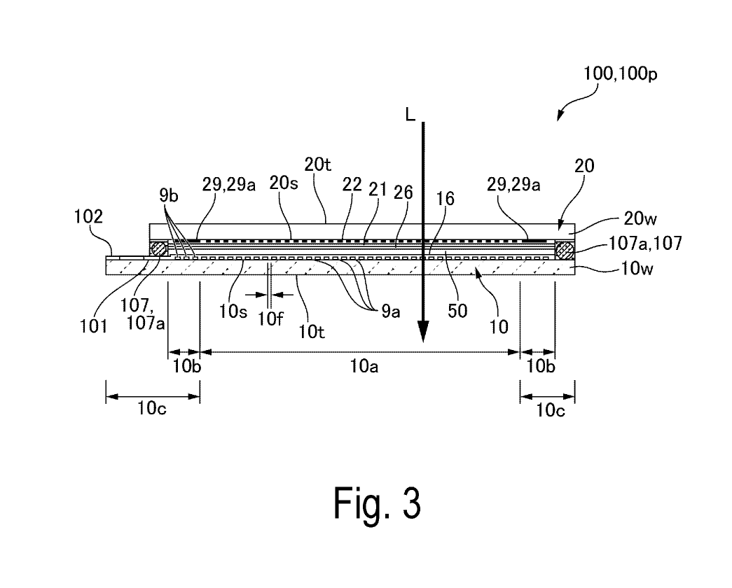

FIG. 2 is a plan view of an electro-optical panel 100p (liquid crystal panel) that is used in the liquid crystal light valves 122a, 122b, and 122c illustrated in FIG. 1. FIG. 3 is an explanatory diagram schematically illustrating a cross section of the electro-optical panel 100p illustrated in FIG. 2. In the description below, a first direction corresponds to an X direction (the horizontal direction), and a second direction corresponds to a Y direction (the vertical direction).

Each of the liquid crystal light valves 122a, 122b, and 122c illustrated in FIG. 2 includes the electro-optical panel 100p (liquid crystal panel) illustrated in FIG. 1 and FIG. 2. In the electro-optical panel 100p, a first substrate 10 and a second substrate 20 are laminated together by a seal material 107 with a predetermined gap in between. The seal material 107 is an adhesive that is formed from a photocurable resin, a thermosetting resin and the like, and further compounded with a gap material 107a, such as a glass fiber and glass beads to maintain a distance between the first substrate 10 and the second substrate 20 to be a predetermined value. In the electro-optical panel 100p, a liquid crystal layer 50 is provided inside a region surrounded by the seal material 107, of a space between the first substrate 10 and the second substrate 20. In the seal material 107, a cut portion 107c is formed that is used as a liquid crystal injection port, and the cut portion 107c is sealed by a sealing material 108 after a liquid crystal material is injected. Note that, in a case where the liquid crystal material is filled using the dropping method, the cut portion 107c is not formed.

The first substrate 10 and the second substrate 20 both have a quadrangle shape, and in a substantially central portion of the electro-optical panel 100p, a display region 10a is provided as a quadrangle region. In accordance with those shapes, the seal material 107 is also formed in a substantially quadrangle shape, and a quadrangle frame-shaped outer peripheral region 10c is provided outside the display region 10a.

In the first substrate 10, a scanning line drive circuit 104 is formed in the outer peripheral region 10c to extend along a first side 10a1 positioned on a first side X1 in a first direction X of the display region 10a. A plurality of terminals 102 are formed in an end portion of the first substrate 10, the end portion being located on a side projecting from the second substrate 20 toward a first side Y1 of a second direction Y, and an inspection circuit 105 is provided in the outer peripheral region 10c to extend along a second side 10a2, which is the opposite side, in the second direction Y, to the plurality of terminals 102 of the display region 10a. Further, in the first substrate 10, the scanning line drive circuit 104 is formed in the outer peripheral region 10c to extend along a third side 10a3 that faces the first side 10a1 in the first direction X. Further, in the first substrate 10, a data line drive circuit 101 is formed in the outer peripheral region 10c to extend along a fourth side 10a4 that faces the second side 10a2 in the second direction Y.

The first substrate 10 includes a light-transmissive substrate main body 10w, such as a quartz substrate or a glass substrate, and of a first surface 10s and a second surface 10t of the first substrate 10 (substrate main body 10w), on the side of the first surface 10s facing the second substrate 20, a plurality of pixel transistors and a plurality of pixel electrodes 9a are formed in a matrix pattern in the display region 10a. The plurality of pixel electrodes 9a are each electrically coupled to a corresponding pixel transistor within the plurality of pixel transistors. A first oriented film 16 is formed on the upper layer side of the pixel electrodes 9a. On the side of the first surface 10s of the first substrate 10, dummy pixel electrodes 9b are formed in a quadrangle frame-shaped region 10b, which is in the outer peripheral region 10c, extending along the side of the display region 10a. The quadrangle frame-shaped region 10b extends between the outer edge of the display region 10a and the seal material 107. The dummy pixel electrodes 9b are simultaneously formed with the pixel electrodes 9a.

The second substrate 20 includes a light-transmissive substrate main body 20w, such as a quartz substrate or a glass substrate, and of a first surface 20s and a second surface 20t of the second substrate 20 (substrate main body 20w), a common electrode 21 is formed on the side of the first surface 20s facing the first substrate 10. The common electrode 21 is formed over substantially an entire surface of the second substrate 20, or is formed as a plurality of strip electrodes, as a region extending across and including a plurality of pixels 100a. In Exemplary Embodiment 1, the common electrode 21 is formed over substantially the entire surface of the second substrate 20.

On the side of the first surface 20s of the second substrate 20, in the frame-shaped region 10b, a light shielding layer 29 is formed on the bottom layer side of the common electrode 21, and a second orientation film 26 is laminated on a surface of the liquid crystal layer 50 side of the common electrode 21. A light-transmissive flattening film 22 is formed between the light shielding layer 29 and the common electrode 21. The light shielding layer 29 is formed as a parting light shielding layer 29a extending along the frame-shaped region 10b, and the display region 10a is defined by the inner edge of the parting light shielding layer 29a. The light shielding layer 29 is also formed as a black matrix portion 29b that overlaps with inter-pixel regions 10f, each of which is sandwiched between the pixel electrodes 9a adjacent to each other. The parting light shielding layer 29a is formed in a position overlapping with the dummy pixel electrodes 9b in a plan view, and the outer peripheral edge of the parting light shielding layer 29a is positioned to have a gap with the inner peripheral edge of the seal material 107. Thus, the parting light shielding layer 29a does not overlap with the seal material 107. The parting light shielding layer 29a (light shielding layer 29) is configured by a light-shielding metal film or a black resin.

The first orientation film 16 and the second orientation film 26 are each an inorganic orientation film including an oblique angle vapor deposition film of SiO_{X}(x≤2), TiO₂, MgO, Al₂O₃ and the like, and each includes a columnar structural body layer, in which columnar bodies, referred to as columns, is formed obliquely with respect to the first substrate 10 and the second substrate 20. Thus, the first orientation film 16 and the second orientation film 26 cause nematic liquid crystal molecules, which have negative dielectric anisotropy used in the liquid crystal layer 50, to be oriented in an obliquely inclined manner with respect to the first substrate 10 and the second substrate 20, thereby causing the liquid crystal molecules to be pre-tilted. In this way, the electro-optical panel 100p is configured as a liquid crystal panel of a normally black vertical alignment (VA) mode.

In the electro-optical panel 100p, outside of the seal material 107, inter-substrate conduction electrode portions 24t are formed at four corner sections on the first surface 20s side of the second substrate 20, and on the first surface 10s side of the first substrate 10, inter-substrate conduction electrode portions 6t are formed at positions facing the four corner sections (the inter-substrate conduction electrode portions 24t) of the second substrate 20. The inter-substrate conduction electrode portions 6t are conductively connected to a common potential line 6s, and the common potential line 6s is conductively connected to common potential application terminals 102a of the terminals 102. Inter-substrate conduction materials 109 including conductive particles are disposed between the inter-substrate conduction electrode portions 6t and the inter-substrate conduction electrode portions for 24t, and the common electrode 21 of the second substrate 20 is electrically coupled to the first substrate 10 side via the inter-substrate conduction electrode portions 6t, the inter-substrate conduction materials 109, and the inter-substrate conduction electrode portions 24t. Thus, a common potential is applied to the common electrode 21 from the first substrate 10 side.

The electro-optical panel 100p of Exemplary Embodiment 1 is a transmission-type liquid crystal device. Thus, the pixel electrodes 9a and the common electrode 21 are each formed of a light-transmissive conductive film, such as an indium tin oxide (ITO) film and an indium zinc oxide (IZO) film. In such an electro-optical panel 100p (transmission-type liquid crystal device), a light source light L entering from the second substrate 20 side is modulated before being emitted from the first substrate 10, and the image light (modulated light) is displayed.

Electrical Configuration of Electro-Optical Panel 100p

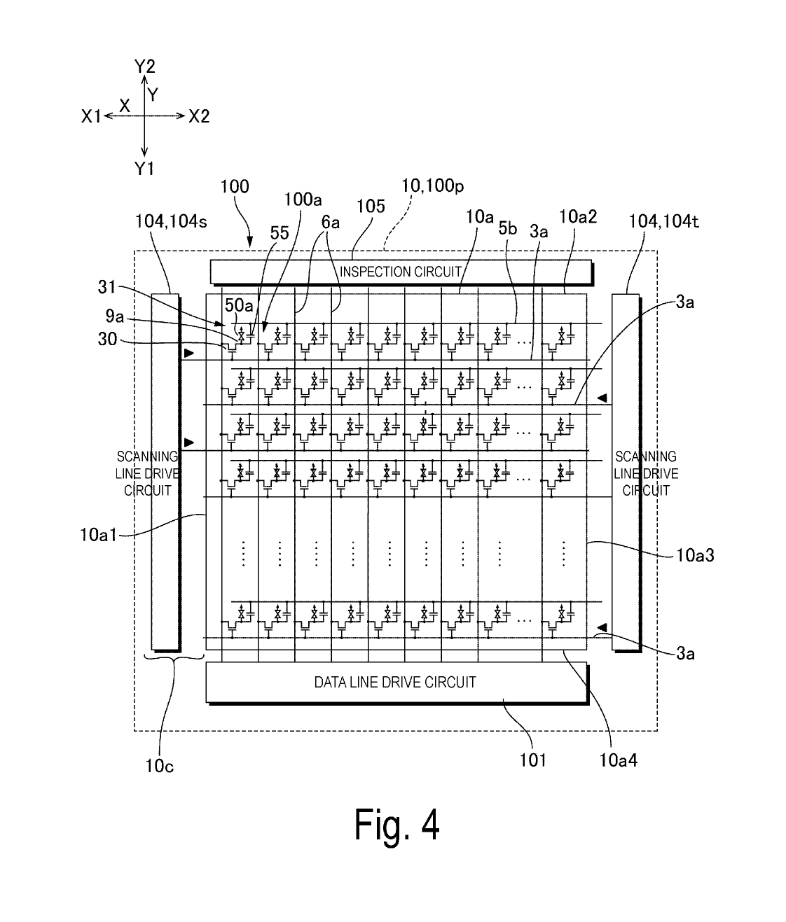

FIG. 4 is a block diagram illustrating the electrical configuration of the electro-optical panel 100p illustrated in FIG. 2. In FIG. 3, the electro-optical panel 100p includes the display region 10a, and in a central region of the display region 10a, the plurality of pixels 100a are arranged in a matrix pattern. In the electro-optical panel 100p, in the first substrate 10 described above with reference to FIG. 2, FIG. 3 and the like, a plurality of scanning lines 3a extending in the X direction and a plurality of data lines 6a extending in the Y direction are formed on the inner side of the display region 10a. The plurality of pixels 100a are formed to correspond to each of intersections between the plurality of scanning lines 3a and the plurality of data lines 6a. The plurality of scanning lines 3a are electrically coupled to the scanning line drive circuits 104, and the plurality of data lines 6a are coupled to the data line drive circuit 101. Further, the inspection circuit 105 is electrically coupled to the plurality of data lines 6a on the opposite side to the data line drive circuit 101 in the second direction Y.

In each pixel 100a, a pixel circuit 31 including a pixel transistor 30 including a field effect transistor or the like is provided, and the pixel electrode 9a is electrically coupled to the pixel transistor 30. The data line 6a is electrically coupled to a source of the pixel transistor 30, the scanning line 3a is electrically coupled to a gate of the pixel transistor 30, and the pixel electrode 9a is electrically coupled to a drain of the pixel transistor 30. An image signal is supplied to the data line 6a, and a scanning signal is supplied to the scanning line 3a.

The pixel electrodes 9a face the common electrode 21 of the second substrate 20, which is described above with reference to FIG. 2 and FIG. 3, via the liquid crystal layer 50, and a liquid crystal element (a liquid crystal capacitor 50a), which includes a liquid crystal layer disposed between a pair of substrates, is configured in each pixel 100a. A holding capacitor 55 disposed in parallel with the liquid crystal capacitor is added to each pixel 100a to prevent fluctuations of the image signal held by the liquid crystal capacitor. In Exemplary Embodiment 1, a capacitance lines 5b extending across the plurality of pixels 100a are formed in the first substrate 10 to configure the holding capacitors 55, and the common potential is supplied to the capacitance lines 5b. In Exemplary Embodiment 1, the capacitance lines 5b extend in the first direction X along the scanning lines 3a.

Specific Configuration of Pixel 100a

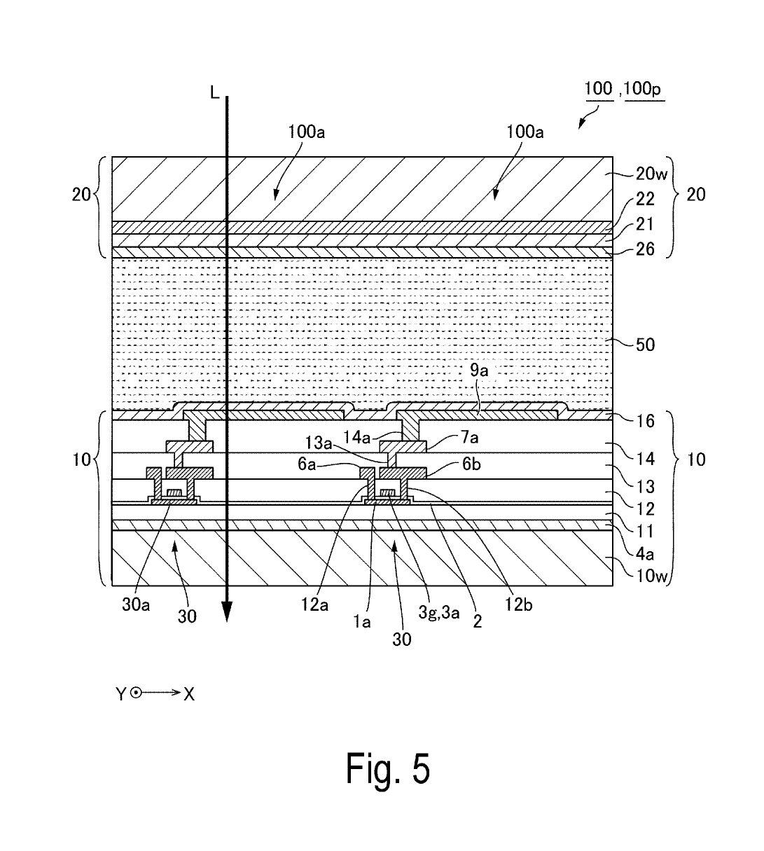

FIG. 5 is a cross-sectional diagram schematically illustrating a configuration example of the pixel 100a of the electro-optical panel 100p illustrated in FIG. 2. As illustrated in FIG. 5, a light shielding layer 4a is formed on the first surface 10s of the first substrate 10. A light-transmissive insulating layer 11 is formed on the upper layer side of the light shielding layer 4a, and the pixel transistor 30 including a semiconductor layer 1a is formed on the top surface side of the insulating layer 11.

The pixel transistor 30 includes the semiconductor layer 1a, a gate insulating layer 2, and the scanning line 3a (a gate electrode 3g) that intersects the semiconductor layer 1a, and includes the light-transmissive gate insulating layer 2 between the semiconductor layer 1a and the gate electrode 3g. The semiconductor layer 1a is configured with a polysilicon film (polycrystalline silicon film) or the like. In Exemplary Embodiment 1, the pixel transistor 30 has an LDD structure. The gate insulating layer 2 has a two-layer structure including a first gate insulating layer including a silicon oxide film that is obtained by thermally oxidizing the semiconductor layer 1a, and a second gate insulating layer including a silicon oxide film that is formed by the low pressure CVD method and the like. Note that, the light shielding layer 4a may serve as the scanning line 3a, and the gate electrode 3 g may be electrically coupled to the light shielding layer 4a (scanning line 3a) via a contact hole (not illustrated), which penetrates through the gate insulating layer 2 and the insulating layer 11.

Light-transmissive interlayer insulating films 12, 13, and 14 (a multi-layered insulating layer) are formed in this order on the upper layer side of the gate electrode 3 g, and the holding capacitors 55 described above with reference to FIG. 4 are configured by utilizing a space between the interlayer insulating films 12, 13, and 14 and the like. In Exemplary Embodiment 1, the data lines 6a and drain electrodes 6b are formed between the interlayer insulating film 12 and the interlayer insulating film 13, and relay electrodes 7a are formed between the interlayer insulating film 13 and the interlayer insulating film 14. The data line 6a is electrically coupled to a source region of the semiconductor layer 1a via a contact hole 12a that penetrates through the interlayer insulating film 12 and the gate insulating layer 2. The drain electrode 6b is electrically coupled to a drain region of the semiconductor layer 1a via a contact hole 12b that penetrates through the interlayer insulating film 12 and the gate insulating layer 2. The relay electrode 7a is electrically coupled to the drain electrode 6b via a contact hole 13a that penetrates through the interlayer insulating film 13. The top surface of the interlayer insulating film 14 is flat, and the pixel electrode 9a is formed on the top surface side (the surface on the liquid crystal layer 50 side) of the interlayer insulating film 14. The pixel electrode 9a is conductively connected to the relay electrode 7a via a contact hole 14a that penetrates through the interlayer insulating film 14. Thus, the pixel electrode 9a is electrically coupled to a drain region of the pixel transistor 30 via the relay electrode 7a and the drain electrode 6b.

In the electro-optical panel 100p configured as described above, in a case where the light source light or stray light enters the pixel transistor 30, an optical leakage current is generated in the pixel transistor 30. Although the entry of light is inhibited by the light shielding layer 4a, the data lines 6a, and the like in Exemplary Embodiment 1, the light source light or the stray light may not be completely blocked from entering into the pixel transistor 30.

### Display Operation

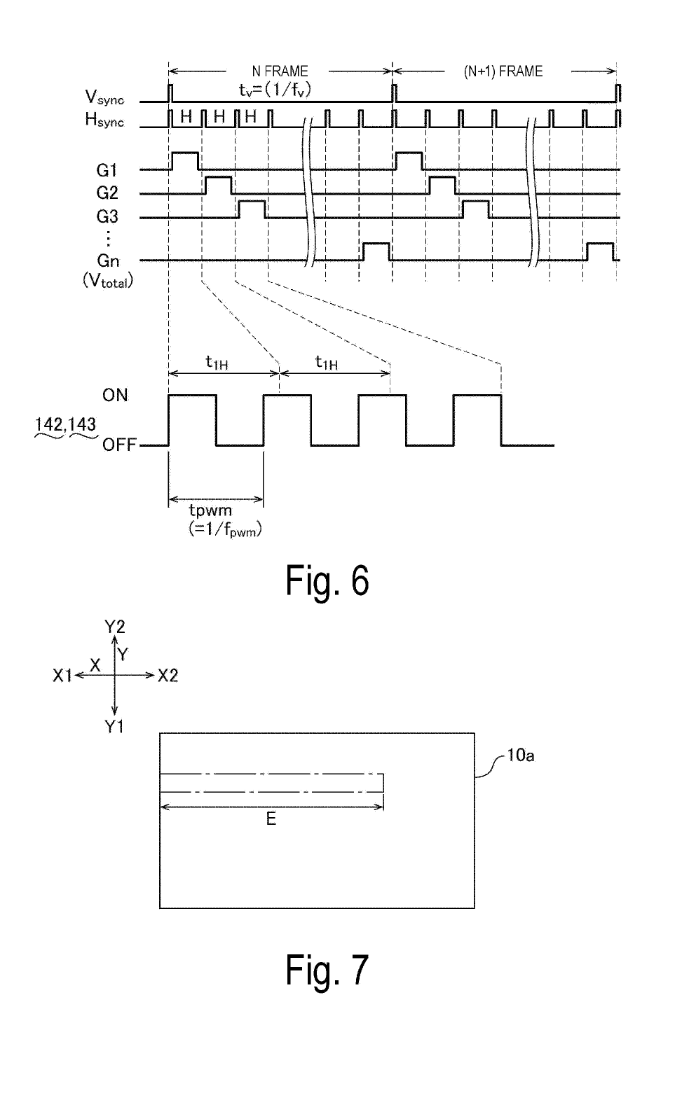

FIG. 6 is an explanatory diagram of the scanning signal and the like supplied to the scanning lines 3a illustrated in FIG. 4. In FIG. 4 and FIG. 6, within one frame (N frame) period, which is defined by a horizontal synchronizing signal Hsync that is synchronized with a vertical synchronizing signal Vsync, the scanning line drive circuits 104 cause scanning signals G1, G2, G3, to Gn sequentially to be exclusively at a high level in every horizontal scan period H. Thus, in the horizontal scan period H, during which the scanning signal G1 is at a high level, the image signals are written into the pixels 100a corresponding to the intersections between the first scanning line 3a and the data lines 6a. Next, in the horizontal scan period H, during which the scanning signal G2 is at a high level, the image signals are written into the pixels 100a corresponding to the intersections between the second scanning line 3a and the data lines 6a. After that, the same operation is repeatedly performed during the period, during which each of the scanning signals G3 to Gn is sequentially at a high level. Further, a similar writing procedure is also performed in a subsequent (N+1) frame. At that time, a polarity of a signal written to each pixel 100a may be reversed. More specifically, if writing a signal of a positive polarity has been performed in the immediately preceding N frame, writing a signal of a negative polarity is performed in the subsequent (N+1) frame, and on the other hand, if the writing a signal of the negative polarity has been performed in the immediately preceding N frame, the writing a signal of the positive polarity is performed in the subsequent (N+1) frame. By performing such polarity reversal, a deterioration of the liquid crystal layer may be prevented.

In the display device 100 configured as described above, when an inverse number of one frame period t_{V} of the electro-optical panel 100p is a panel frequency fᵥ, a cycle of one horizontal scanning period is t_{1H}, a total number of the scanning lines 3a per one frame of the electro-optical panel 100p (total number of scanning lines) is Vₜₒₜₐₗ, and an inverse number of a pulse width modulation cycle t_{pwm} of the laser light sources 142 and 143 (light emitting elements) is a PWM frequency f_{pwm}, each of the values is set in the following manner.

First, as illustrated in FIG. 6, the pulse width modulation cycle t_{pwm} is not greater than the cycle of one horizontal scan period t_{1H}, and the pulse width modulation cycle t_{pwm} and the cycle of one horizontal scan period t_{1H} satisfy the following relationship (1):

t_{1H}≥t_{pwm}=1/f_{pwm} (1).

Here, the one frame period t_{V}, the panel frequency f_{V}, the cycle of one horizontal scan period t_{1H}, the total number of scanning lines Vₜₒₜₐₗ and the PWM frequency f_{pwm} have a relationship expressed by the following equation (2):

t_{1H}=t_{V}/Vₜₒₜₐₗ=(1/f_{V})·(1/Vₜₒₜₐₗ) (2).

Thus, the following relationship (3) is established based on the relationships (1) and (2):

(1/f_{V})·(1/Vₜₒₜₐₗ)≥1/f_{pwm} (3).

Thus, the following relationship (4) is established:

f_{pwm}≥f_{V}·Vₜₒₜₐₗ (4).

For example, in a case where the resolution is WXGA, and the panel frequency f_{V} is 120 Hz, the PWM frequency f_{pwm} becomes 96 kHz.

### Main Effects of Exemplary Embodiment 1

FIG. 7 is an explanatory diagram illustrating a state in which scroll noise is suppressed as a result of the disclosure being applied.

As described above, the display device 100 of Exemplary Embodiment 1 satisfies the above-described relationship (4). Thus, when writing the image data into each pixel 100a coupled to the scanning line 3a selected during the horizontal scan period H, even in a case where the optical leakage current is generated in the pixel transistor 30 during the illumination period of the pulse width modulation on the laser light sources 142 and 143 (light emitting elements), the pixels 100a whose luminance decreases as a result of the optical leakage current are only a part of the pixel rows arranged in the horizontal direction. Thus, as illustrated in FIG. 7, the pixels 100a whose luminance has decreased and is lower than the luminance of the pixels 100a, in which the image data has been written during the period when the laser light sources 142 and 143 are turned off, exist only in a part (in a range indicated by arrows E) in the horizontal direction (first direction X). Therefore, a stripe-like gradation difference does not occur in the entire region over the horizontal direction. Thus, even in a case where the plurality of scanning lines 3a are sequentially scanned, the pixels 100a with reduced luminance appear in different positions in the horizontal direction. Thus, even in a case where the pulse width modulation method is used for driving the laser light sources 142 and 143, which are used as the light source, generation of the scroll noise may be suppressed.

In particular, in Exemplary Embodiment 1, the electro-optical panel 100p is used for the projection-type display device 1000, and a strong light source light is irradiated. Thus, the optical leakage current is more likely to be generated in the pixel transistor 30. However, even in such a case, the generation of the scroll noise is suppressed according to Exemplary Embodiment 1.

### Exemplary Embodiment 2

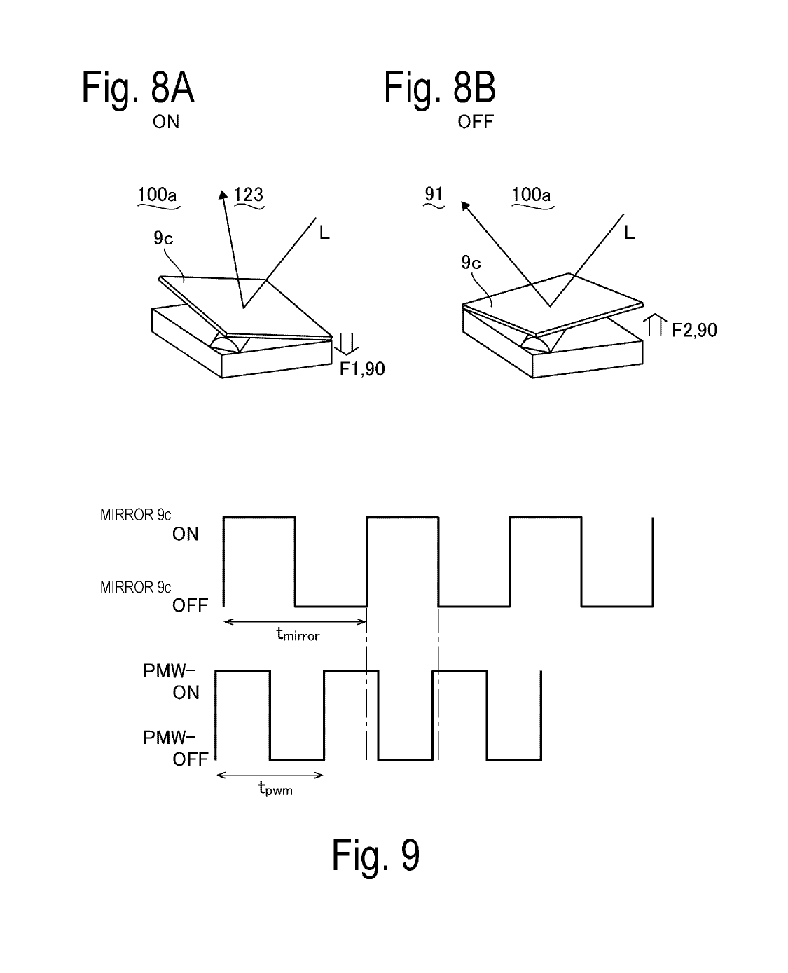

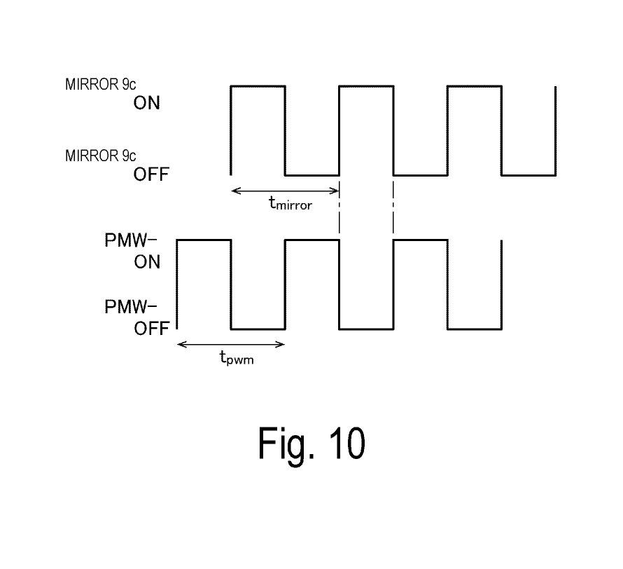

FIGS. 8A and 8B are explanatory diagrams of the electro-optical panel using a digital mirror device, which is used in place of the liquid crystal light valve, in the projection-type display device 1000 illustrated in FIG. 1. FIG. 8A illustrates an ON state, and FIG. 8B illustrates an OFF state. Note that, in FIGS. 8A and 8B, directions that an actuator 90 actuates a mirror 9c are indicated by arrows F1 and F2. FIG. 9 is an explanatory diagram illustrating a relationship between the PWM cycle t_{pwm} and a drive cycle tₘᵢᵣᵣₒᵣ in Exemplary Embodiment 2 of the disclosure. FIG. 10 is an explanatory diagram illustrating a relationship between the PWM cycle t_{pwm} and the drive cycle tₘᵢᵣᵣₒᵣ in a reference example in relation to Exemplary Example 2 of the disclosure.

In Exemplary Embodiment 1, each pixel 100a includes the liquid crystal element that includes the liquid crystal layer disposed between the pair of substrates. In contrast, in Exemplary Embodiment 2, as illustrated in FIGS. 8A and 8B, each pixel 100a includes the mirror 9c and the actuator 90 that actuates the mirror 9c, and in each pixel 100a, the actuator 90 is controlled by a unit circuit. The actuator 90 changes a posture of the mirror 9c based on an image signal, and modulates the light source light L. More specifically, as illustrated in FIG. 8A, in the ON state in which the actuator 90 actuates the mirror 9c in a direction indicated by the arrow F1, the light source light L is reflected by the mirror 9 and travels toward the projection optical system 123 (see FIG. 1). In contrast, as illustrated in FIG. 8B, in the OFF state in which the actuator 90 actuates the mirror 9c in a direction indicated by the arrow F2, the light source light L is reflected by the mirror 9c, travels toward a light absorption board 91, and does not travel toward the projection optical system 123 (see FIG. 1). Such a modulation operation is performed in each pixel 100a. At that time, the actuator 90 actuates the mirror 9c at a predetermined actuating frequency fₘᵢᵣᵣₒᵣ, and controls the gradation by a ratio between an ON period and an OFF period.

Similarly to Exemplary Embodiment 1, in the electro-optical panel also configured in this manner, for the purpose of suppressing the generation of the scroll noise, the panel frequency f_{V}, the total number of scanning lines Vₜₒₜₐₗ and the PWM frequency f_{pwm} satisfy the above-described relationship (4).

Further, in Exemplary Embodiment 2, the PWM frequency f_{pwm} and the drive frequency fₘᵢᵣᵣₒᵣ satisfy the following relationship (5):

f_{pwm}>fₘᵢᵣᵣₒᵣ (5).

Specifically, in a case where the PWM cycle t_{pwm} is not less than the drive cycle tₘᵢᵣᵣₒᵣ of the actuator 90, as illustrated in FIG. 10, there may be a case in which the entire ON period of the mirror 9c overlaps with an OFF period of the PWM depending on a PWM duty ratio. Thus, in Exemplary Embodiment 2, as expressed by the relationship

t_{pwm}<tₘᵢᵣᵣₒᵣ,

the PWM cycle t_{pwm} is shorter than the drive cycle tₘᵢᵣᵣₒᵣ. In other words, the above-described relationship (5) is satisfied. Thus, in a case where the drive cycle tₘᵢᵣᵣₒᵣ is 10 microseconds, the PWM frequency f_{pwm} is greater than 100 kHz.

According to this configuration, as illustrated in FIG. 9, regardless of the PWM duty ratio, an ON period of the PWM overlaps with at least part of an ON period of the mirror 9c. Thus, the light source light L is reliably modulated.

Other Electro-Optical Panels 100p

In the above-described Exemplary Embodiments, an example is described in which the scanning line 3a is sequentially driven one by one. However, the disclosure may be applied to a case in which the scanning line 3a is sequentially driven at every multiple scanning line. Further, the disclosure may be applied to a case in which a frame sequential method is adopted, namely, in which the image data is sequentially written into the pixels 100a coupled to each scanning line 3a, and, at a timing at which the writing is completed in all the pixels 100a, the image data written in each pixel 100a is displayed.

Further, the electro-optical panel 100p is the transmission-type liquid crystal panel in Exemplary Embodiment 1. However, the disclosure may be applied to a case in which the electro-optical panel 100a is a reflection-type liquid crystal panel. The electro-optical panel 100p is the liquid crystal panel in the above-described Exemplary Embodiment 1. However, the disclosure may be applied to a case in which the electro-optical panel 100p is an electrophoretic display device.

Other Projection-Type Display Devices

The three liquid crystal light valves 122a, 122b, and 122c are used in the above-described Exemplary Embodiments. However, one or two liquid crystal light valves may be used to configure the projection-type display device. Further, a light emitting element, such as a laser element and a light emitting diode, which emits light of each color, may be used as the light source unit, and each of the colored lights emitted from the light emitting element may be supplied to the electro-optical panel 100p such as the liquid crystal light valve.

Other Electronic Apparatuses

Applications of an electronic apparatus including the display device 100 to which the disclosure is applied, are not limited to the projection-type display device 1000 of the above-described Exemplary Embodiments. For example, the electronic apparatus may be a projection-type head-up display (HUD), a direct viewing-type head-mounted display (HMD), a personal computer, a digital camera, a liquid crystal television, and the like.

[1] The entire disclosure of Japanese Patent Application No. 2017-150474, filed Aug. 3, 2017 is expressly incorporated by reference herein.

What is claimed is:

1. A display device, comprising:
a light emitting element configured to emit a light source light, the light source light being pulse-width modulated; and
an electro-optical panel configured to modulate the light source light, wherein
the electro-optical panel includes:
a plurality of scanning lines extending along a first direction,
a plurality of data lines extending along a second direction intersecting the first direction, and
a plurality of pixels, each pixel including a pixel circuit, the pixel circuit being provided to correspond to each of intersections between the plurality of scanning lines and the plurality of data lines, and the pixel circuit including a transistor, and
a panel frequency f_{V}, a total number of scanning lines Vₜₒₜₐₗ, and a PWM frequency f_{pwm} satisfy a relationship
f_{pwm}≥f_{V}·Vₜₒₜₐₗ
where the panel frequency f_{V} is an inverse number of one frame period t_{V} of the electro-optical panel, Vₜₒₜₐₗ is a total number of scanning lines per one frame of the electro-optical panel, and f_{pwm} is a PWM frequency of pulse width modulation of the light emitting element.

2. The display device according to claim 1, wherein
the light emitting element is a laser element.

3. The display device according to claim 1, wherein
each pixel includes a liquid crystal element including a liquid crystal layer disposed between a pair of substrates.

4. The display device according to claim 1, wherein
each pixel includes a mirror configured to reflect the light source light, and an actuator configured to actuate the mirror.

5. The display device according to claim 4, wherein
the PWM frequency f_{pwm} and a drive frequency fₘᵢᵣᵣₒᵣ satisfy a relationship
f_{pwm}>fₘᵢᵣᵣₒᵣ
where the drive frequency fₘᵢᵣᵣₒᵣ is a drive frequency of the mirror by the actuator.

6. An electronic apparatus comprising:
the display device according to claim 1.

7. The electronic apparatus according to claim 6, further comprising:
a projection optical system configured to project modulated light obtained by the electro-optical panel modulating the light source light.

8. A method of driving a display device, the display device including
a light emitting element configured to emit a light source light, the light source light being pulse-width modulated; and
an electro-optical panel configured to modulate the light source light,
the electro-optical panel includes a plurality of scanning lines extending along a first direction, a plurality of data lines extending along a second direction intersecting the first direction, and a plurality of pixels, each pixel including a pixel circuit, the pixel circuit being provided to correspond to each of intersections between the plurality of scanning lines and the plurality of data lines, and the pixel circuit including a transistor, wherein
a panel frequency f_{V}, a total number of scanning lines Vₜₒₜₐₗ, and a PWM frequency f_{pwm} satisfy a relationship
f_{pwm}≥f_{V}·Vₜₒₜₐₗ
where the panel frequency f_{V} is an inverse number of one frame period t_{V} of the electro-optical panel, Vₜₒₜₐₗ is a total number of scanning lines per one frame of the electro-optical panel, and f_{pwm} is a PWM frequency of pulse width modulation of the light emitting element.
